(19) United States
(12) Patent Application Publication
(10) Pub. No.: US 2009/0009423 A1
(43) Pub. Date: Jan. 8, 2009

(54) Variable size electronic display based on slide-out and slide-in mechanism

(76) Inventors: Yuming Huang, (US); Weihua Wang, (US); Yujian Huang, (US)

Correspondence Address: YUMING HUANG, 810 MEADOWRIDGE DRIVE, AURORA, IL, 60504, US

(21) Appl. No.: 11/774,592

(22) Filed: Jul. 7, 2007

(51) Int. Cl. G09G 5/00

(52) U.S. Cl. 345/1.1

(57) ABSTRACT

The size of an electronic display is increased when display panels are slide-out from a stack beneath the top display panel. The slide-out display panels and the top display panel form one larger rigid and smooth display. The slide-out display panels can be slide back into the stack under the top display panel. A device bearing the above display works with different sizes of the display (caused by display panels slide-out and slide-in). Display panels not slide-out may not have power in order to save energy.

### 1. FIELD OF THE INVENTION

This invention relates generally to the display or screen of an electronic device. The size of the display is changeable based on slide-out and slide-in mechanism, in order to accommodate various purposes.

### 2. BACKGROUND

A major problem facing portable electronic device (mobile phone, portable computers, etc.) is that easy carrying requires small size device. Portable device can not bear large size single-piece display unless the size is changeable. One solution is folding. A method (fold or crease) is described in United States Patent Application #20050099361. There is even a prototype, called “Philips Readius E-Reader With Rollable Display” (FIG. 13 through FIG. 16). It is a rollable display which has different unfolding mechanism in the above patent. One shortcoming is that, the prototype is not in working status before unfolding. Another solution is provided in this invention which has more advantages.

### 3. DESCRIPTION OF THE INVENTION

In this invention, the size of an electronic device display is changed by slide-out and slide-in mechanism. The slide-out (slide-in) mechanism is different from the unfolding (folding) mechanism of U.S. Pat. No. 6,523,288 and United States Patent Application #20050099361.

The slide-out and slide-in mechanism is exploited by various commercial products, for example, sliding door and sliding keyboard beneath the screen of a cell phone. The slide-out and slide-in mechanism in this invention refers to any such mechanism that is not protected by other patents (expired or unpatented).

The electronic device display includes (but is not limited to) cell phone screen, computer screen, LCD, CRT, DLP, touch screen, multi-touch screen. The display is an output media to show visual information. In addition to be an output media, the display may act as an input media, for example, touch screen may show a “soft” keyboard for users to type in info.

There are two or more display panels which are slide-in below the top display panel (FIG. 1, FIG. 6). When all the display panels are slide-in, the display maintains its minimum size. Hence is the device, for easy carry. Some or all display panels may slide-out in certain direction and in certain order which may be fixed or changeable. (FIG. 2, FIG. 4; FIG. 7; FIG. 9, FIG. 11). The display reaches its maximum size when all its display panels are slide-out (FIG. 3, FIG. 5, FIG. 10, FIG. 12).

For each display panel, it may slide-out (and slide-in) automatically or manually. When it is fully slide-out, the sliding mechanism holds (by lock, latch, rail, . . . ) it into place and raises it onto same height as the top display panel and other slide-out panels (FIG. 3, FIG. 5, FIG. 8, FIG. 10, FIG. 12).

The horizontal gap between (slide-out) neighboring display panels is minimized. If the outside boundary is made of different material than the display material, for example, metal, the boundary is moved to form a new outside boundary of the final established display. The final surface is a larger, rigid, and smooth display. The height of the boundary (which corresponds to the thickness of display panels stack) may be changeable. The boundary may have multiple layers so that all the display panel outer sides are protected by at least one layer of the boundary.

There are mechanical, electrical, and electronic connections among display panels and the control system of the electronic device. The control system detects what panels are slide-out (and slide-in) and the shape of the final display. The slide-out panels may be power up automatically. The control system may choose appropriate display format according to the size and shape of the final working display. For example, wide screen (FIG. 5, FIG. 12).

When all the display panels of the device are slide-in, the device works in the minimum display size mode (FIG. 1, FIG. 6). For a cell phone, users may make phone calls. Since all slide-in panels are power off, battery lasts longer. If they want to browse the Internet, display panels are slide-out to form a larger screen allowing them similar experience of a desktop PC (FIG. 3, FIG. 10).

The orientation of all the display panels can be same or different. The slide-in and slide-out mechanism do not change the orientation. The folding and unfolding mechanism described in United States Patent Application #20050099361, may need to rotate display panels in order to form one larger display with all the panels facing same orientation. In this invention, if all the display panels share same orientation when they are slide-in, no panel rotation is needed when slide-out to form one larger display with all the panels facing same orientation.

It is obvious that all the non user interface parts of the device (CPU, memory, . . . ) can be hide somewhere, for example, beneath display panels. User interface parts (other than the display), for example, camera, microphone, speaker, buttons, connection ports can be installed to the bottom or the outer boundary of the device.

### 4. DESCRIPTION OF THE DRAWINGS OF THE PREFERRED EMBODIMENT

It is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation.

FIG. 1 shows an electronic device with two display panels which are all slide-in. This is a working mode of the device.

FIG. 2 shows the bottom display panel of FIG. 1 is slide-out in one direction (another direction is in FIG. 4), and will raise to the same height as the top display panel (FIG. 3). This is not a working mode of the device.

FIG. 3 shows an electronic device with two display panels which are all slide-out. The size of the display doubles. This is a working mode of the device.

FIG. 4 shows the bottom display panel of FIG. 1 is slide-out in another direction and will raise to the same height as the top display panel (FIG. 4). This is not a working mode of the device.

FIG. 5 shows an electronic device with two display panels which are all slide-out in different direction as that in FIG. 3. The size of the display doubles but it is more like a wide screen than FIG. 3. This is a working mode of the device.

FIG. 6 shows an electronic device with four display panels which are all slide-in. This is a working mode of the device.

FIG. 7 shows the two bottom display panels of FIG. 6 are slide-out and will raise to the same height as the two top display panels (FIG. 8). This is not a working mode of the device.

FIG. 8 shows the two bottom display panels of FIG. 6 are slide-out and raises to the same height as the two top display panel. The size of the display doubles. This is a working mode of the device.

FIG. 9 shows the new two bottom display panels of FIG. 8 are slide-out and will raise to the same height as the new two top display panels (FIG. 10). This is not a working mode of the device.

FIG. 10 shows an electronic device with four display panels which are all slide-out. The size of the display quadruples. This is a working mode of the device.

FIG. 11 shows the new two bottom display panels of FIG. 8 are slide-out in another direction (than FIG. 9) and will raise to the same height as the new two top display panels (FIG. 12). This is not a working mode of the device.

FIG. 12 shows an electronic device with four display panels which are all slide-out. The size of the display quadruples but with different dimensions than FIG. 10. This is a working mode of the device.

What is claimed is:

1. A display for an electronic device, comprising two or more individual display panels which are configured to be slide-out to increase the size of the display, and to be slide-in to decrease the size of the display (and the size of the device) for possibly easy carrying, storage, etc.

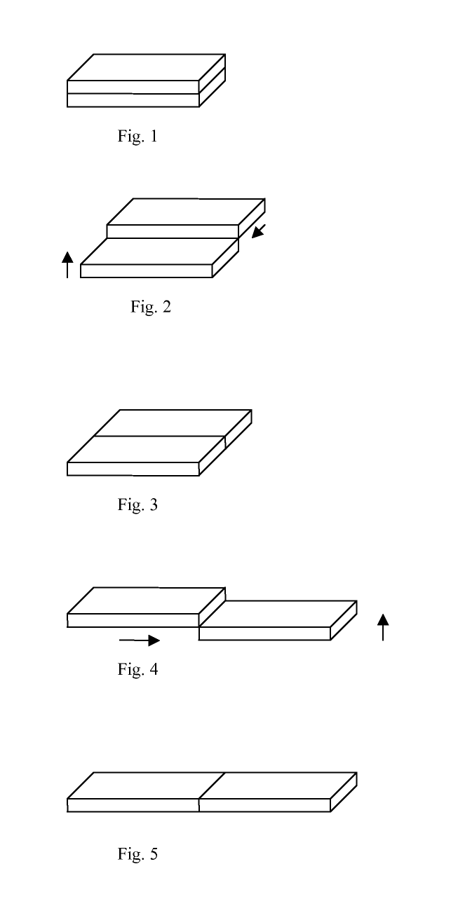

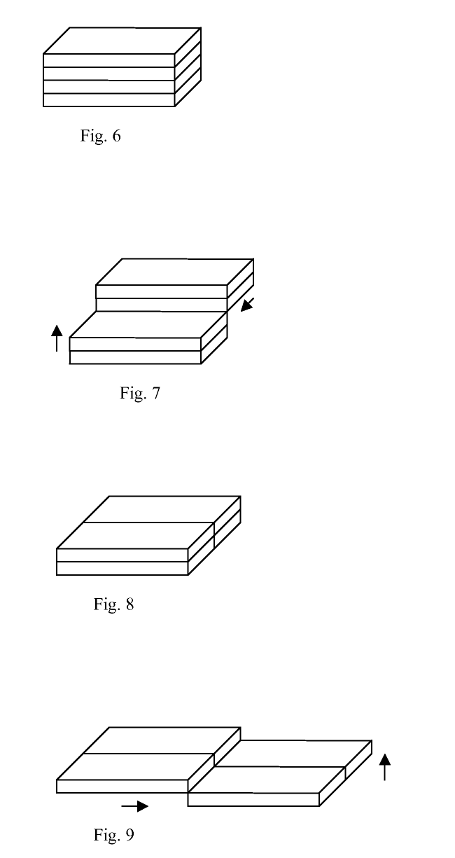

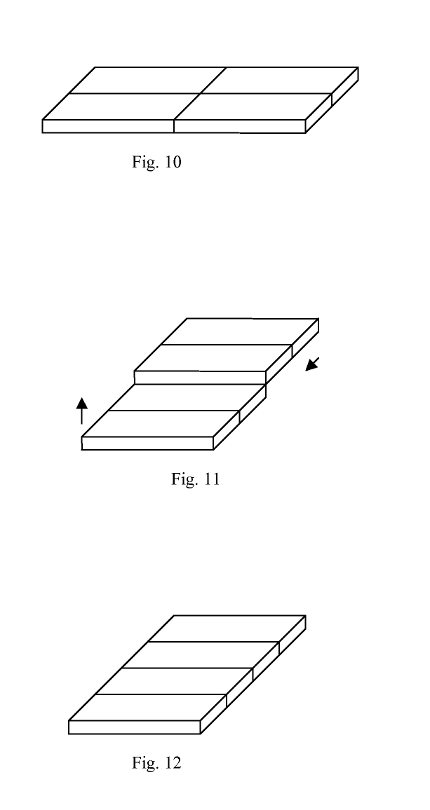

2. The device of claim 1, when all the display panels are slide-in, the display reaches its minimum size which is the size of the top display panel (FIG. 1, FIG. 6). The device may work in this minimum display size mode.

3. The device of claim 1, when all the display panels are slide-out, the display reaches its maximum size (FIG. 3, FIG. 5, FIG. 10, FIG. 12). The device may work in this maximum display size mode.

4. The device of claim 1, when some display panels are slide-in and some are slide-out (FIG. 8), the device may work in this display size mode.

5. For claim 2 and 4, when the device is power on, only the top display panel and slide-out panels have power in order to save energy.

6. The device of claim 1, is a mobile communication device, including but not limited to, cell phone, wireless phone, iphone, blackberry.

7. The device of claim 1, has no hardware keyboard.

8. The device of claim 1, has a hardware keyboard.

9. The device of claim 1, is a portable computer, including but not limited to, PDA, handheld PC, pocket PC, palm PC, notebook PC.
